(19) United States
(12) Patent Application Publication
(10) Pub. No.: US 2026/0337072 A1
(43) Pub. Date: Oct. 29, 2026

(54) Counter-diffusion of greenhouse gases for energy recovery

(71) Applicant: The Board of Trustees of the Leland Stanford Junior University, Stanford, CA (US)

(72) Inventors: Chungheon Shin, Los Altos, CA (US); Craig S. Criddle, San Luis Obispo, CA (US); Sebastien Tilmans, Bethesda, MD (US)

(21) Appl. No.: 19/118,961

(22) PCT Filed: Oct. 14, 2023
(86) PCT No.: PCT/US2023/035164

§ 371 Date: Apr. 7, 2025

Related U.S. Application Data
(60) Provisional application No. 63/416,375, filed on Oct. 14, 2022.

(51) Int. Cl. C02F 3/12; C02F 3/10; C02F 3/34

(52) U.S. Cl. CPC C02F 3/1268; C02F 3/102; C02F 3/342; C02F 2209/34

(57) ABSTRACT

Biological treatment of wastewater with a membrane aerated biofilm reactor (MABR) produces an output effluent and off-gas containing N₂O and O₂ from the gas-permeable membranes that have attached aerobic and anoxic biofilms. The MABR has hollow fibers or spirally wound sheets, and it also includes an off-gas collection/extraction system from a lumen of the gas permeable membranes to outside of MABR. A gas containing oxygen flows through the lumen of gas-permeable membranes, thereby creating concentration gradients of oxygen, N₂O, CO₂, and methane. The gas recovered from an off-gas collection system is beneficially used, such as for energy recovery while minimizing greenhouse gas emissions.

### FIELD OF THE INVENTION

The present invention relates generally to wastewater treatment. More specifically, it relates to methods and systems for secondary or tertiary wastewater treatment incorporating membrane aerated biofilm reactors (MABRs) for removal of biodegradable compounds in the water and mitigation of greenhouse gas (GHG) emissions.

### BACKGROUND OF THE INVENTION

Conventional wastewater treatment is based upon aerobic treatment where aerobic microorganisms oxidize biodegradable contaminants with O₂ as an oxidant. Many different configurations have been developed, including conventional activated sludge (CAS), anoxic/oxic (A/O), e.g., Bardenpho, and anaerobic/anoxic/oxic (A²/O), including modified Bardenpho. These processes are a major source of greenhouse gas (GHG) emissions due to the need for energy-intensive aeration and release of nitrous oxide (N₂O).

Recently, membrane aerated biofilm reactors (MABRs) have become more popular. These systems were designed to improve aeration efficiency by bubble-free aeration as opposed to bubble-based aeration or use of mixing devices. The gas-permeable membranes of MABRs support growth of aerobic biofilms on the membranes. O₂ gradients drive diffusion within these biofilms, enabling energy-efficient treatment. The MABR thus enables reduction of GHG emissions for energy use but does not reduce GHG emissions due to N₂O. A recent systems-level analysis emphasizes that N₂O emissions result in a larger carbon footprint than the footprint resulting from energy use for aeration (Shin et al., 2022a). A method for N₂O emission control in aerobic systems is clearly needed.

Many different configurations have also been developed for anaerobic secondary treatment, including upflow anaerobic sludge blanket bioreactors (UASBs), anaerobic fluidized bed reactors (AFBRs), and anerobic membrane bioreactors (AnMBRs). New anaerobic secondary treatment systems, such as the staged anaerobic fluidized-bed membrane bioreactors (SAF-MBRs), are emerging that can enable net energy positive operation. Within these systems, anaerobic microbial communities efficiently convert biodegradable organic matter into methane gas that is harvested for energy production, but considerable methane remains dissolved in the effluent. To maximize energy recovery and avoid GHG emissions, this methane must be managed or recovered. Sulfide and ammonia are also present and must be removed. Methane can be recovered by physical processes, such as methane stripping, or can be removed by biological processes with methane-oxidizing bacteria; sulfide by chemical precipitation or biological oxidation from sulfide-oxidizing bacteria; and ammonia by biological oxidation or physicochemical processes for recovery of ammonia. At present, however, a solution is still needed for effective management of N₂O emissions in secondary and tertiary systems.

### SUMMARY OF THE INVENTION

Herein we disclose a method for N₂O management for both aerobic and anaerobic secondary and tertiary treatment systems. This system is based upon the MABR in which aerobic biofilms create a driving force for counter diffusion of N₂O from the membrane-attached biofilm into the lumen of hollow fibers or spirally wound sheets. This driving force increases N₂O concentration within the lumen, facilitating recovery of N₂O-enriched off-gas for energy production in a biogas engine or in a system that recovers combined heat and power (CHP).

Biofilms attached to membrane surfaces within the MABR use O₂ from air delivered through the lumen and support growth of aerobic biofilms that remove biodegradable compounds from the aqueous phase, including dissolved methane, ammonia, sulfide, and organic matter. Biofilms attached to these membranes contain methane-oxidizing bacteria (MOB), ammonia-oxidizing bacteria (AOB), ammonia-oxidizing archaea (AOA), sulfide-oxidizing bacteria (SOB), and denitrifiers. Nitrification requires O₂ and includes oxidation of hydroxylamine (NH₂OH) to nitric oxide (NO) and N₂O. Denitrification requires reduction of NO to N₂O with coupled electron donors (e.g., H₂, CH₄, organic matter, such as glycogen and polyhydroxybutyrate). During nitrification and denitrification, N₂O can be released incidentally or deliberately.

N₂O accumulates to high concentrations within biofilms, enabling counter-diffusion where N₂O exits the biofilm and enters the lumen while O₂ exits the lumen and enters the biofilm. The result is an N₂O partial pressure gradient that favors recovery of higher N₂O concentrations within the off-gas exiting the lumen. The recovered N₂O is a higher energy oxidant than O₂ and can be used as a co-oxidant with O₂ in CHP applications and biogas engines while reducing GHG emissions. At present, the MABR industry is unaware of potential applications involving N₂O recovery. MABRs incorporate gas permeable membranes (e.g., polymethyl pentene, PMP), and can be configured in various forms including hollow fibers or spirally wound sheets. Gas permeable membranes provide two key functions: (1) provision of oxygen to support the activity of aerobic and anoxic biofilms containing diverse heterotrophic microorganisms, along with methane-, sulfide-, ammonia-, and nitrite-oxidizing bacteria, as well as denitrifiers, and (2) counter diffusion of potent GHGs, including N₂O and CH₄ which can then be concentrated, recovered, and combusted in a biogas engine.

Use of the proposed counter diffusion MABR process significantly reduces carbon footprint for both aerobic-, anoxic- and anaerobic-based wastewater treatment by enabling recovery of more than 99% produced N₂O during nitrification through off-gas that can be combined with biogas and combusted for power generation. For anaerobic-based treatment systems, the proposed process greatly simplifies management of nitrogen, sulfide, and dissolved methane with low energy consumption enabling net-energy positive operation.

Air or pure oxygen continuously flows through the membrane lumen in the MABR and creates concentration gradients of oxygen, nitrous oxide, and methane, which facilitate simultaneous consumption of oxygen with production of nitrous oxide followed by its counter diffusion. MABR membranes are often equipped with a diffuser located at the base of the membrane modules, designed for intermittent scouring and mixing (e.g., 15 scfm for 10 seconds every two minutes, as per ZeeLung operation protocols, Veolia) and for biofilm thickness control (e.g., 30 scfm for 3 minutes every 12 hours, as per ZeeLung operation protocols, Veolia).

Because MABRs incorporate biofilms attached to the exterior of the membranes, solids residence time (SRT) of the microorganisms is uncoupled from hydraulic residence time (HRT), allowing the system to maintain robust removal of sulfide, methane, and nitrogen at a short HRT. Because oxygen supply is based on bubble-free diffusion, MABR energy consumption is small compared to that of conventional bubble-based aeration systems (greater than 2.5 kgO₂/kWh for MABR vs. less than 1 kgO₂/kWh for bubble-based aeration).

The atmospheric air or pure O₂ that is delivered to the membrane lumen does not contain high levels of N₂O (450 ppb in the air) or CH₄ (1900 ppb in the air), thereby creating concentration gradients that enable counter diffusion of N₂O and dissolved CH₄ from the liquid phase. During NH₃ removal, N₂O is incidentally produced by organisms including aerobic ammonia-oxidizing and anoxic denitrifying bacteria, creating a high concentration gradient of N₂O within the biofilm. The N₂O diffuses down a concentration gradient into the lumen where it is swept out of the MABR system for use (e.g., through combustion) or management. Anaerobic secondary effluent containing dissolved CH₄ also enters the MABR (typically 20 mg-CH₄/L) where it is subject to either biodegradation and/or physical removal from the aqueous phase due to diffusion and the creation of a concentration gradient.

Off-gas from the membrane lumen contains two oxidants-O₂ (over 16%) and N₂O (over 40 ppm), and a potent fuel-CH₄ (2~4%) which can be combusted together in a biogas engine, enabling effective greenhouse gas emission control with recovery of energy. Biogas can be supplied by anaerobic systems, including anaerobic digesters and/or anaerobic secondary treatment. The oxidant to fuel ratio (O/F) for biogas combustion can be adjusted by adding biogas from anaerobic digestion of primary solids, a common process in conventional wastewater treatment processes.

The SAF-MBR followed by the MABR process train described in this disclosure is currently being evaluated at pilot-scale (over 100 days) at Silicon Valley Clean Water (SVCW), a centralized wastewater treatment facility at Redwood City, CA. The SAF-MBR system treats 90 m³ of primary effluent per day, enabling net energy positive operation (0.49 kWh/m³ energy produced minus 0.24 kWh/m³ from energy used=0.25 kWh/m³) while producing high-quality effluent with low COD. The MABR treats over 8.2 m³ per day of SAF-MBR effluent, requiring less than 0.03 kWh/m³ of energy for aeration. This energy requirement is off-set by energy produced by the SAF-MBR and enables the process train to maintain net energy positive operation (over 0.2 kWh/m³).

Testing of the SAF-MBR/MABR system and laboratory testing indicates that the combined systems can improve reliability and versatility for both aerobic- and anerobic-based wastewater treatment options. Inclusion of aerobic MABR biofilms downstream of the SAF-MBR provides a second barrier for protection of water quality in the effluent and control of ammonia and sulfide, and also prevents release of potent GHGs, as demonstrated in this disclosure.

In summary, innovations disclosed herein include: 1) MABRs for removal of biodegradable compounds and recovery of concentrated N₂O (exceeding ppm levels), a potent GHG subject to counter-diffusion and elevated concentration within the lumen, and 2) off-gas recovery and utilization from MABRs, containing gases including both O₂ and N₂O, and can be coupled to a biogas engine for GHGs emission control while generating more power.

In one aspect, the invention provides a method for biological treatment of wastewater based upon a membrane aerated biofilm reactor (MABR). The method includes: a) processing a wastewater influent in a membrane aerated biofilm reactor (MABR) to produce an output effluent and an off-gas from gas-permeable membranes of the MABR, where the off-gas comprises N₂O and O₂; b) collecting the off-gas from the MABR using the off-gas collection system; and c) recovering energy and/or greenhouse gases from the collected off-gas. The MABR comprises aerobic and anoxic biofilms attached to the gas-permeable membranes.

The gas-permeable membranes comprise hollow fibers or spirally wound sheets. The MABR comprises an off-gas collection system connecting a lumen of the gas permeable membranes of the MABR to an exterior of the MABR. The processing of wastewater influent in the MABR comprises flowing an aerated gas containing oxygen through the lumen of gas-permeable membranes creating concentration gradients for O₂, N₂O, CO₂, and CH₄.

In some implementations, the wastewater influent is an effluent from a secondary wastewater treatment system. In some implementations, the wastewater influent is an effluent from a primary wastewater treatment system. In some implementations, a concentration of N₂O in the off-gas exceeds 1 ppm. In some implementations, recovering energy and/or greenhouse gases comprises using a fuel cell generator, biogas combustion system, or combined heat and power (CHP) system to produce energy from the off-gas.

In some implementations, the aerobic and anoxic biofilms contain heterotrophs, ammonia-oxidizing bacteria (AOB), methane-oxidizing bacteria (MOB), sulfide-oxidizing bacteria (SOB), ammonia-oxidizing archaea (AOA), nitrite-oxidizing bacteria (NOB), or denitrifying anoxic organisms. In some implementations, the aerobic biofilms contain organisms that possess ammonia monooxygenase enzymes that consume O₂ and use it to produce hydroxylamine which can be further oxidized to N₂O. In some implementations, the gas permeable membranes are composed of polymethyl pentene (PMP). In some implementations, the off-gas collection system comprises an exhaust tube, pipe, or gas line.

### BRIEF DESCRIPTION OF THE DRAWINGS

FIG. 1 is a schematic diagram of a conventional wastewater treatment system using conventional activated sludge.

FIG. 2 is a schematic diagram of two variations of a conventional advanced activated sludge process enabling biological nitrogen removal (BNR).

FIG. 3 illustrates schematically three conventional BNR processes, incorporating nitritation or partial nitritation.

FIG. 4 illustrates three available configurations of wastewater treatment based upon bubble-based aeration to deliver oxygen to aerobic bacteria.

FIGS. 5A-5B is a cross-sectional view of a lumen of gas permeable membranes (FIG. 5A) and an associated graph of O₂ concentration gradient (FIG. 5B).

FIG. 6 is side view of a hollow fiber type gas permeable membrane with biofilm attached.

FIG. 7 illustrates a conventional membrane aerated biofilm reactor (MABR) with bubble-free aeration, where N₂O emissions are measured from the top of the reactor.

FIG. 8A is a cross-sectional view of a hollow fiber type gas permeable membrane with biofilm attached, illustrating how nitrification on the surface of membranes coated with biofilm results in more concentrated nitrous oxide, according to an embodiment of the invention.

FIG. 8B is a graph illustrating a counter-diffusion of N₂O from a concentration gradient corresponding to the membrane lumen shown in FIG. 8A.

FIG. 9 is a schematic diagram of a pilot-scale MABR which allows over 99.9% of produced N₂O to be separately collected from the membrane off-gas through an off-gas collection line, according to an embodiment of the invention.

FIG. 10 illustrates a system and method for N₂O emission control based upon MABR wastewater treatment, according to an embodiment of the invention.

FIG. 11 is a schematic diagram illustrating a use of an MABR in an aerobic secondary treatment process with secondary clarifier, according to an embodiment of the invention.

FIG. 12 illustrates a system for aerobic secondary treatment incorporating both MABR and MBR, according to an embodiment of the invention.

FIG. 13 illustrates a system for an anaerobic secondary treatment followed by an MABR and clarifier, according to an embodiment of the invention.

FIG. 14 illustrates a system for anaerobic secondary treatment followed by MABR and MBR, in which MABR off-gas is coupled to a CHP combusting biogas produced from anaerobic digestion and anaerobic secondary treatment, according to an embodiment of the invention.

FIG. 15 illustrates a system in which primary effluent enters anaerobic secondary treatment where the output enters MABR producing a discharge or effluent for advanced treatment water reuse, according to an embodiment of the invention.

FIG. 16 is a side view of a hollow fiber type gas permeable membrane with biofilm attached, for use in embodiments of the invention with anaerobic secondary treatment of effluent followed by MABR.

FIG. 17 illustrates configurations with anaerobic secondary treatment of primary effluent followed by MABR with nitrifier activity controls for subsequent ammonia recovery in water reuse trains, according to an embodiment of the invention.

FIG. 18 illustrates a system with anaerobic secondary treatment followed by MABR with inhibited methanotrophic activity, according to an embodiment of the invention.

FIG. 19 illustrates a system with anaerobic secondary treatment of primary effluent, in which an MABR is followed by a dissolved methane stripping system, according to an embodiment of the invention.

FIG. 20 is a flowchart outlining a method for biologically treating wastewater according to an embodiment of the invention.

FIG. 21 is a schematic diagram of a demonstration-scale staged anaerobic fluidized-bed membrane bioreactor (SAF-MBR) system feeding a pilot-scale MABR, according to an embodiment of the invention.

FIG. 22 is a schematic diagram of a pilot-scale MABR, according to an embodiment of the invention.

FIG. 23 is a graph showing influent ammonia (left column) and inorganic nitrogen species in the MABR effluent, as a fraction (%) of the influent ammonia, according to an embodiment of the invention.

FIGS. 24A-24B illustrate how N₂O can be recovered through a membrane lumen, according to an embodiment of the invention, where FIG. 24A is a cross-sectional view of a gas permeable membrane fiber and FIG. 24B shows a graph of the N₂O concentration gradient as a function of penetration distance x into the fiber.

FIG. 25 is a schematic diagram illustrating an SAF-MBR followed by MABR process train for energy- and carbon efficient secondary treatment of primary effluent, according to an embodiment of the invention.

### DETAILED DESCRIPTION

For over 100 years, municipal wastewater treatment has relied on aerobic secondary treatment processes (e.g., activated sludge) to remove dissolved organic carbon, thereby preventing the development of depleted oxygen conditions in surface waters receiving the wastewater discharges. However, aerobic secondary processes require energy-intensive aeration and result in high cell yields, increasing production of waste biosolids (Shin et al., 2021a). Aerobic processes involve significant greenhouse gas emissions associated with the energy required for aeration, transport of biosolids to landfills, and decomposition of biosolids in the landfills, in addition to the direct emission of N₂O at facilities that practice nitrification/denitrification for N removal (IPCC, 2019). Rising concerns over climate change and the dwindling availability of pristine water supplies in arid regions have promoted the development of municipal wastewater treatment systems that are less energy-intensive while facilitating wastewater reuse.

Recent interest has focused on the development of anaerobic secondary treatment systems, where anaerobic microorganisms ferment dissolved organics, avoiding energy-intensive aeration while producing methane that can be harvested for energy generation. Anaerobic microorganisms also feature lower cell yields, thereby reducing biosolids production and shrinking the footprint required for solids treatment. Due to the slow growth of anaerobic microorganisms, Anaerobic Membrane Bioreactors (AnMBRs) have been favored, because the membranes enable a high solids retention time (SRT) to accommodate the slow growth of anaerobic microorganisms and to retain complex organic matter, facilitating hydrolysis to monomers, at short hydraulic residence times (HRTs). Among the AnMBRs, the Staged Anaerobic Fluidized-bed Membrane Bioreactor (SAF-MBR) has achieved outstanding performance at both pilot-(Shin et al., 2014; Shin et al., 2021a) and demonstration-scale (Shin et al., 2022b). The SAF-MBR incorporates fluidized granular activated carbon (GAC) as a biocarrier for anaerobic biofilms (Shin, et al., 2021b), separating the mean cell residence time of anaerobic microorganisms (MCRT) from the SRT of suspended solids. The biocarriers enable >500-day MCRTs (Shin et al., 2012; Shin et al., 2021b), while reducing the mixed liquid suspended solids (MLSS), thereby minimizing membrane fouling. Our previous research at pilot-scale has indicated that SAF-MBR treatment can achieve net energy-positive operation (Shin et al., 2021a) while reducing greenhouse gas emissions (Shin et al., 2022a).

Despite its promise, the SAF-MBR faces three challenges associated with its anaerobic operation that can hinder wastewater reuse. First, approximately 30% to 60% of the methane generated within the SAF-MBR remains dissolved in the SAF-MBR effluent and prior to reuse. Second, the anaerobic conditions prevent must be removed nitrification/denitrification, such that the high level of ammonia in SAF-MBR effluent could prevent environmental discharge or water reuse (e.g., irrigation). Third, sulfide generation by biological sulfate reduction typically precedes methane production. In addition to reducing the methane production potential, soluble sulfides persist in SAF-MBR effluent. These sulfides are toxic, corrosive, release odorous gas (H₂S) and create scale. Furthermore, sulfides can interfere with the two primary disinfection processes used for wastewater treatment by exerting demand for chlorine or chloramine or by absorbing UV photons. Previous research has evaluated sulfide precipitation using iron-based coagulants with polymers (Evans et al., 2018) but the costs of iron reagents and disposal of precipitates were prohibitive. Lee et al., 2019 used a vacuum degasifier to extract dissolved sulfide and methane, but sulfide removal was less than 90%, even with pH control. Alternatively, researchers have investigated removal of sulfides by biological oxidation using Membrane-aerated Biofilm Reactors (MABRs). Within the MABR, oxygen is supplied to aerobic biofilms attached to membranes by diffusion of oxygen from air passing through the lumen. The MABR can achieve high oxygen transfer rates with low energy consumption by avoiding energy-intensive bubble aeration, while avoiding stripping of volatile compounds and odors into the exhaust gas.

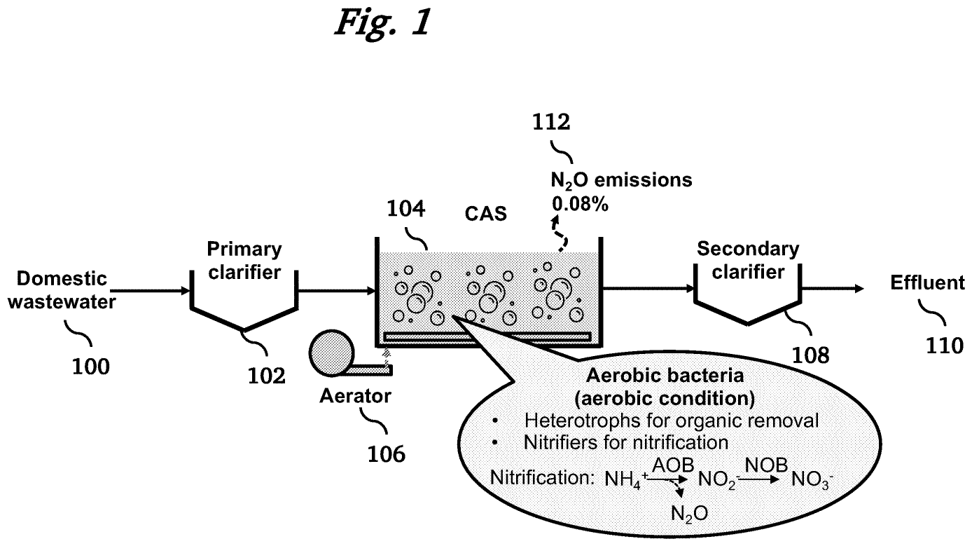

The limitations and challenges of the techniques described above are illustrated in FIGS. 1-7. Specifically, FIG. 1 shows a wastewater treatment plant that processes domestic wastewater 100 by passing it into a primary clarifier 102, a conventional activated sludge process 104 with aerator 106, and a secondary clarifier 108 to produce an effluent. 110.

The operation results in a high carbon footprint, largely due to nitrous oxide (N₂O) emissions 112 in aerobic systems. Under aerobic respiration, N₂O is incidentally produced mainly from ammonia-oxidizing bacteria (AOB). N₂O is a potent greenhouse gas with a global warming potential 298 times that of CO₂ for a 100-year timescale (IPCC, 2013).

Conventional activated sludge (CAS) processes focus on removal of organic matter and make use of aerobic heterotrophic bacteria without biological nitrogen removal (BNR). But aerobic conditions stimulate growth of nitrifiers, including both AOB and nitrite oxidizing bacteria (NOB). CAS without BNR has an N₂O emission factor of 0.008 kg-N₂O—N/kg-N or 0.8% based upon influent nitrogen (IPCC, 2019), resulting in a carbon footprint of 0.15 kg-CO₂ eq/m³.

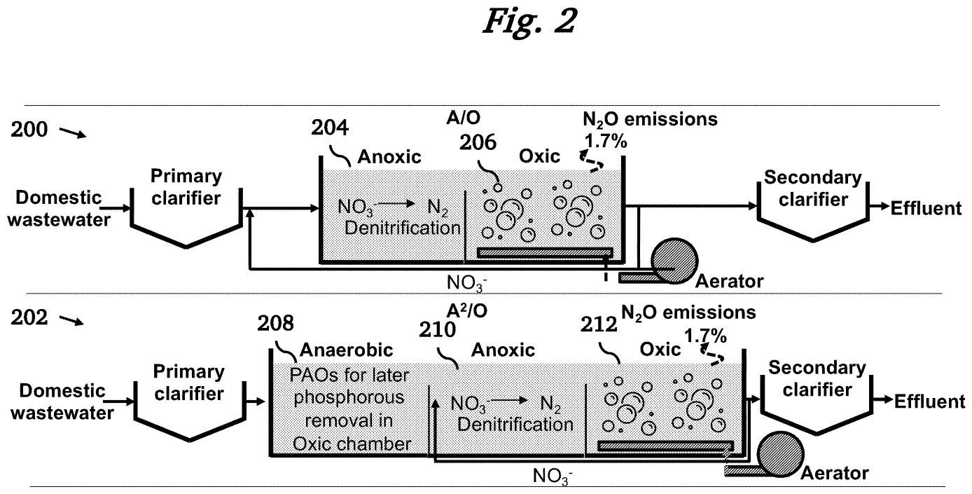

FIG. 2 shows advanced activated sludge processes enabling BNR: On the top 200 is A/O (anoxic 204 and oxic 206, e.g., Bardenpho) and on the bottom 202 is shown A²/O (anaerobic 208, anoxic 210 and oxic 212, e.g., modified Bardenpho). These systems provide longer solids residence time (SRT) to contain more nitrifiers but result in a higher N₂O emission factor of 0.017 kg-N₂O—N/kg-N or 1.7% based upon influent nitrogen (IPCC, 2019), corresponding to a carbon footprint of 0.32 kg-CO₂ eq/m³. Carbon footprints from N₂O emissions of these systems are even greater than the carbon footprint due to energy consumption of 0.11 kg-CO₂ eq/m³, a major carbon footprint in wastewater treatment plants (Shin et al., 2022a).

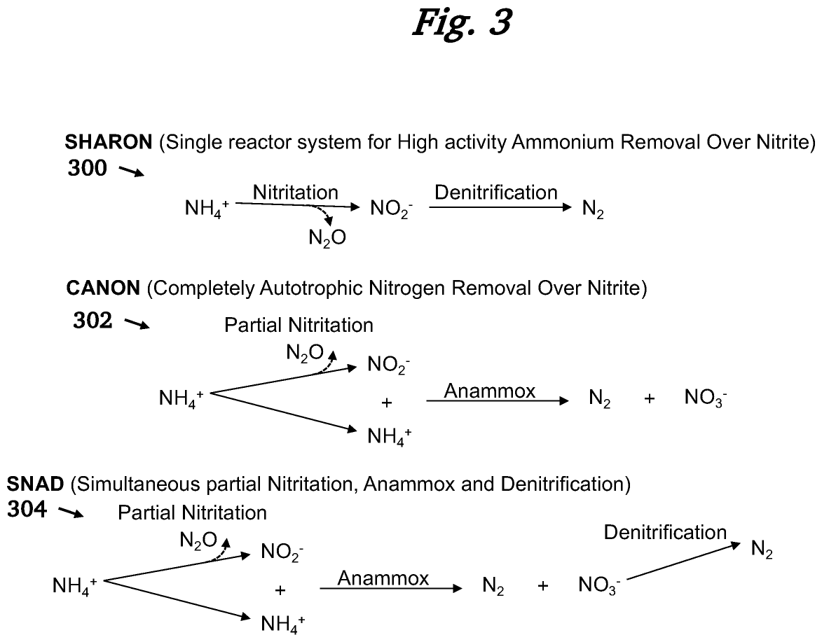

FIG. 3 illustrates schematically three other BNR processes, incorporating nitritation or partial nitritation. These processes have been developed to decrease energy consumption and the requirement for organic electron donor. The single reactor system for high activity ammonium removal over nitrite (SHARON) 300 incorporates nitritation and denitrification. Completely autotrophic nitrogen removal over nitrite (CANON) 302 incorporates partial nitritation and anammox. The simultaneous partial nitritation, anammox and denitrification (SNAD) 304 enables complete nitrogen removal from simultaneous partial nitritation, anammox and denitrification. However, a recent systems-level study (Shin et al., 2022a) reported that nitritation can result in higher N₂O emissions than previous systems due to its higher emission ratio of 0.027 kg-N₂O—N/kg-N (or 2.7% of influent nitrogen).

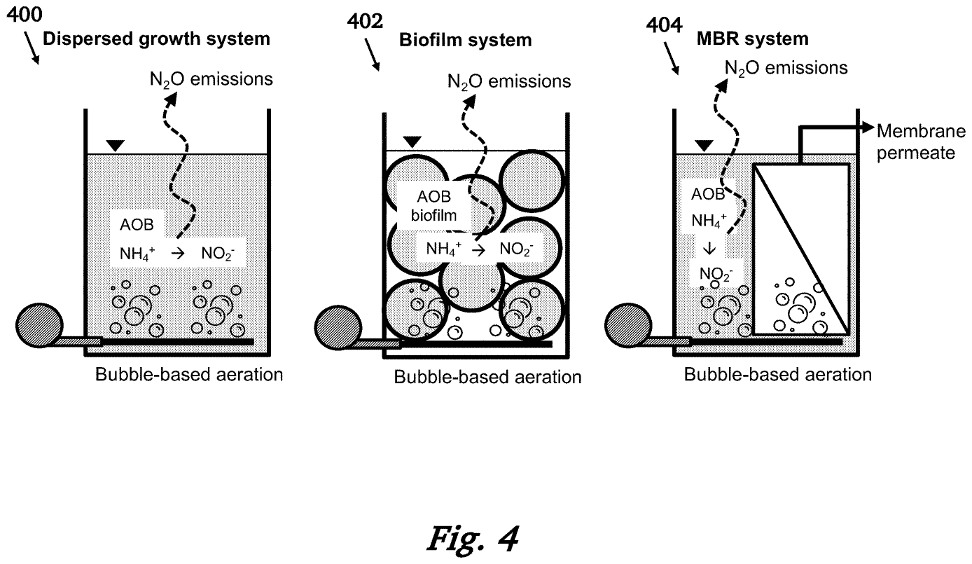

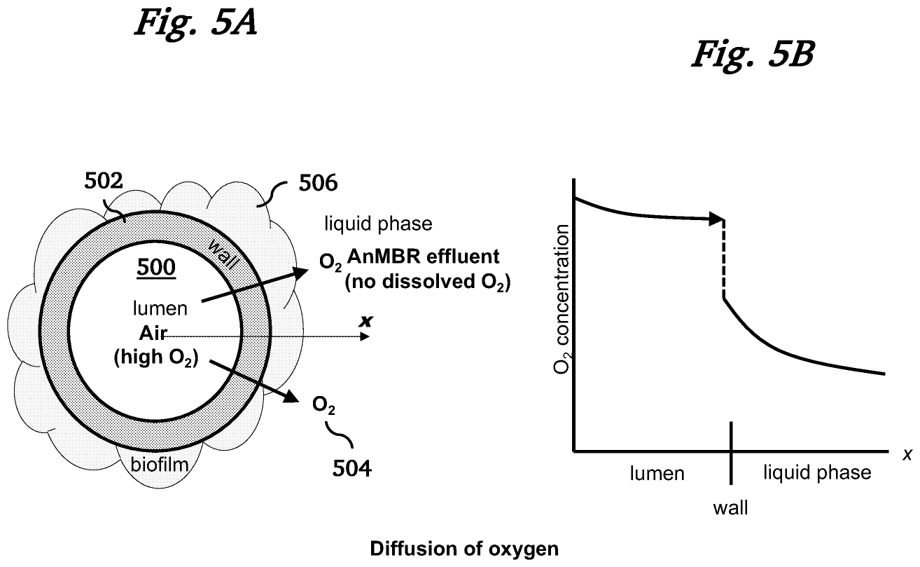

To date, most wastewater treatment plants are based upon bubble-based aeration to deliver oxygen to aerobic bacteria. FIG. 4 illustrates three available configurations: dispersed growth 400, biofilm 402, and membrane bioreactor (MBR) 404. Membrane-aerated biofilm reactors (MABR) were invented more recently (in the 2000s) to improve aeration efficiency by incorporating gas permeable membranes for bubble-free aeration. FIG. 5A schematically illustrates how air 500 flows inside the membranes within the lumen wall 502, creating a concentration gradient (shown in the graph of FIG. 5B) and diffusion of oxygen (O₂) 504 to the biofilm on the membrane surface 506.

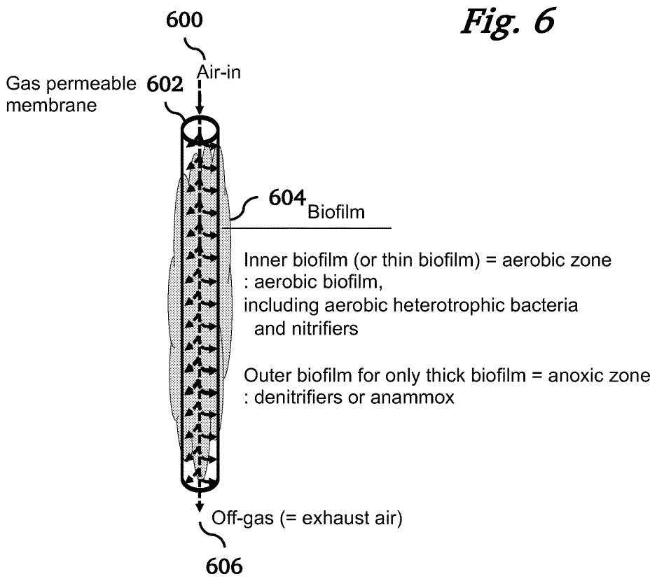

There are at least two different types of gas permeable membranes available for MABRs: hollow fibers (from Veolia and Oxymem) and spirally wound sheets (from Fluence). FIG. 6 illustrates a hollow fiber design, showing air 600 passing through the lumen of a hollow fiber 602 having a biofilm 604 attached to its surface. Exhaust air with off-gas 606 exits the opposite end of the fiber 602. For thin biofilm systems, the biofilm contains only aerobic bacteria. For thicker biofilm systems (>100 μm), the inner biofilm will be aerobic and favorable for aerobes, but the outer biofilm will be anoxic and favorable to nitrifiers or anammox.

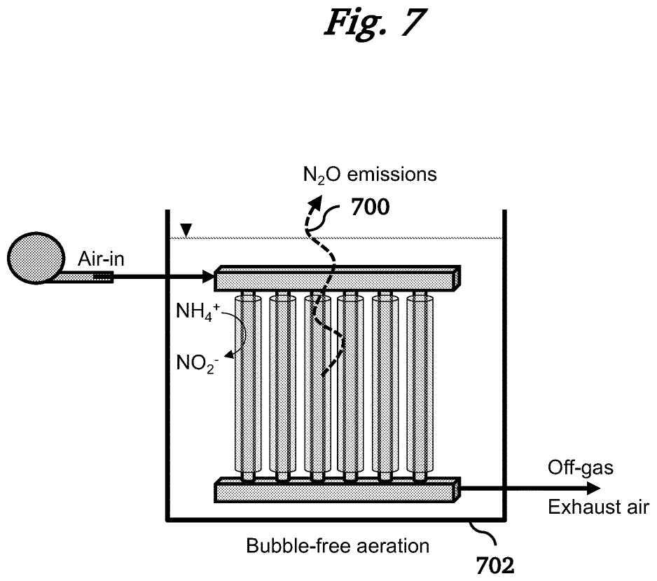

At present, industry has solely monitored N₂O emissions obtained from the headspace of the MABR, as conventionally practiced in previous reactor configurations. FIG. 7 illustrates an MABR with bubble-free aeration, where N₂O emissions 700 are measured from the top of the reactor 702.

In contrast to current practice, the present inventors have recognized the potential of counter diffusion or degasification of N₂O using gas permeable membranes in MABRs.

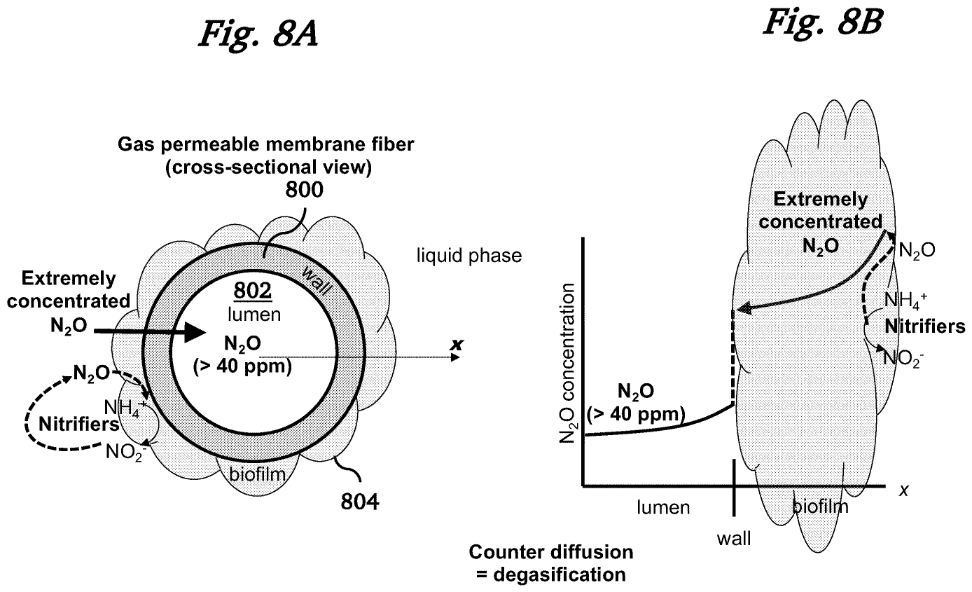

FIG. 8A illustrates how nitrification on the surface of membranes 800 coated with biofilm 804 results in more concentrated nitrous oxide, which will then create a counter-concentration gradient (see graph, FIG. 8B), in which the nitrous oxide diffuses back into the membrane lumen 802 for degasification of N₂O. In general, conventional strategies for wastewater treatment with MABR reactors seek to minimize N₂O formation. This invention applies to the production and recovery of N₂O. In doing so, it avoids greenhouse gas emissions while harnessing N₂O for beneficial purposes.

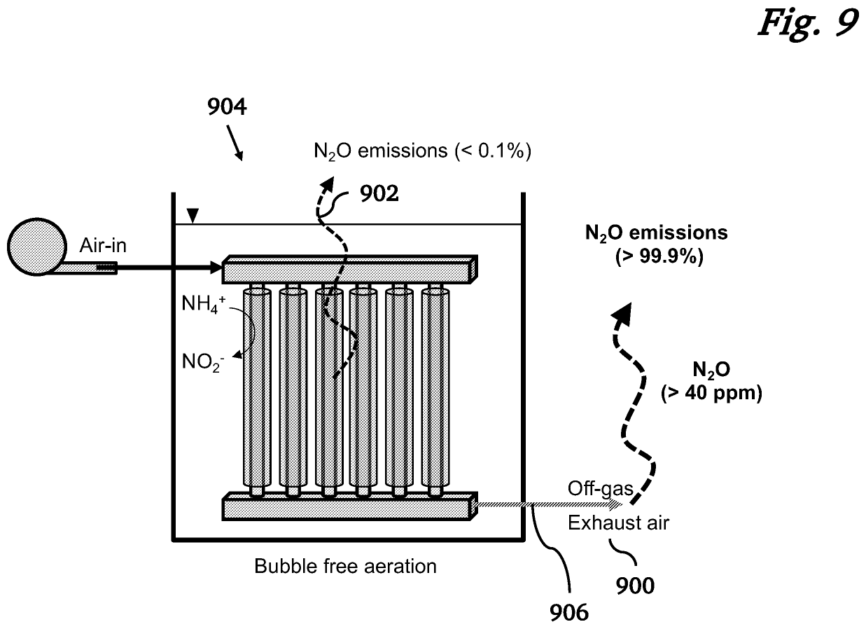

The inventors have operated a pilot-scale MABR 904 for over 100 days. Their investigations have determined that over 99.9% of produced N₂O can be separately collected from the MABR membrane off-gas (or exhaust air) 900 through an off-gas collection line 906, while less than 0.01% of total produced N₂O remained in the reactor headspace 902, as illustrated in FIG. 9. The MABR off-gas can contain >40 ppm N₂O.

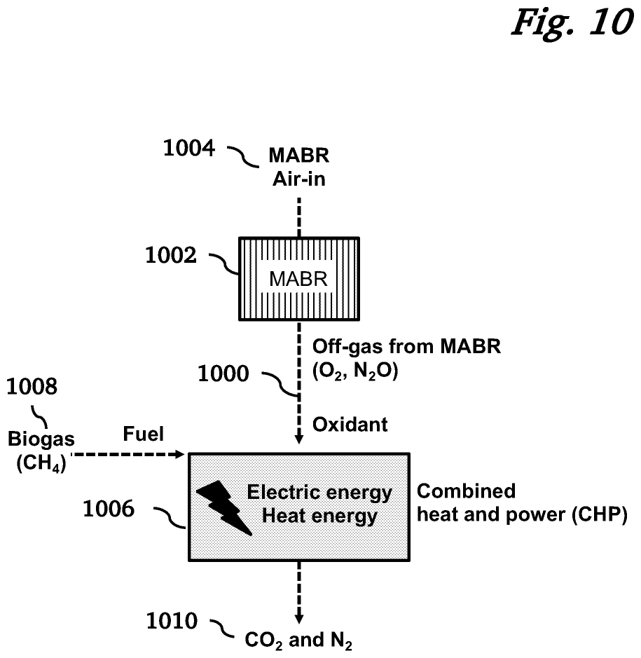

FIG. 10 illustrates a system and method for N₂O emission control based upon MABR wastewater treatment. Off-gas, including N₂O, 1000 from an MABR 1002 fed with air 1004 enables significant N₂O emission mitigation in wastewater treatment plants. MABR off-gas 1000 containing both O₂ and N₂O can be used as an oxidant for combined heat and power (CHP) 1006 or a generator combusting fuel, such as biogas methane 1008, for production of CO₂ and N₂ as output products 1010. This method features (1) significant carbon footprint reduction in wastewater treatment and (2) improved efficiency of energy recovery because N₂O is a more potent oxidant than O₂.

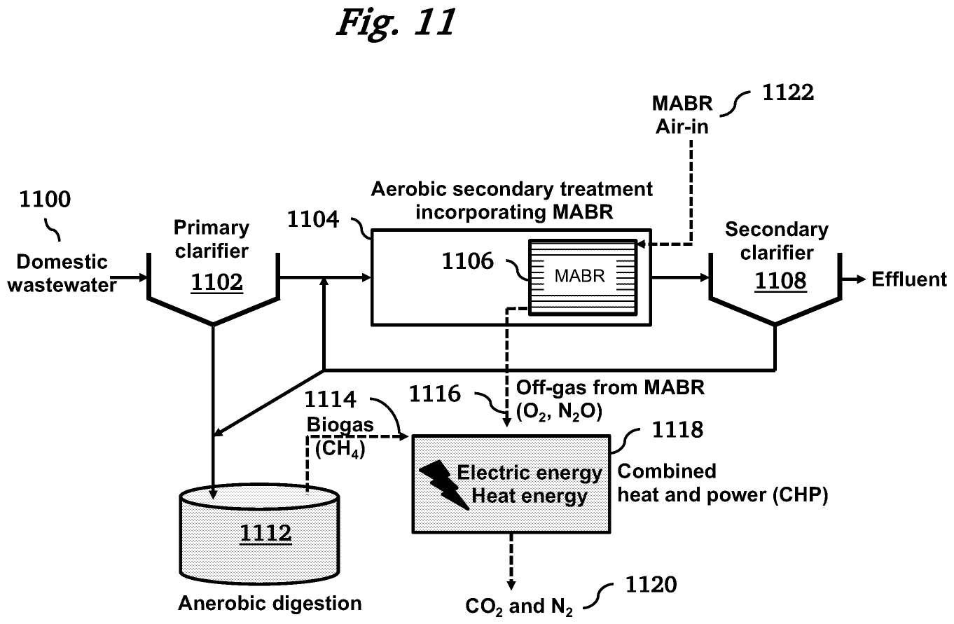

FIG. 11 shows an embodiment of the invention, illustrating a potential configuration of application to MABR 1106 as an aerobic secondary treatment process 1104 with secondary clarifier 1108. MABR off-gas 1116 will be coupled to the CHP 1118 combusting biogas 1114 produced from anaerobic digestion 1112, treating solids waste from primary clarifier 1102 and secondary clarifier 1108. Here, the aerobic secondary treatment process 1104 can also include any BNR system, such as SHARON, CANON, and SNAD. Domestic wastewater 1100 is fed into the primary clarifier 1102, and treated effluent 1110 exits from the secondary clarifier 1108. Air 1122 is pumped into the MABR 1106, and off-gas from the MABR 1106 is fed into the combined heat and power system 1118 to produce CO₂ and N₂ as output products 1120.

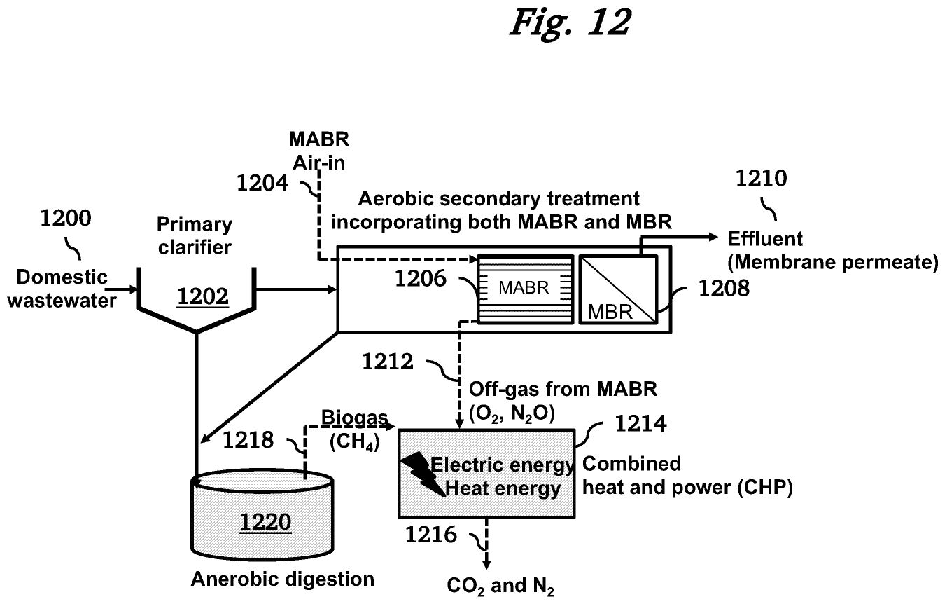

FIG. 12 illustrates another embodiment and potential configuration of application to aerobic secondary treatment process incorporating both MABR 1206 and MBR 1208. In this case, MABR off-gas 1212 will be coupled to the CHP 1214 combusting biogas 1218 produced from anaerobic digestion 1220 which treats solids waste from primary clarifier 1202 and secondary treatment 1206. Here, aerobic secondary treatment processes can include any BNR system, such as SHARON, CANON, and SNAD. Domestic wastewater 1200 flows into primary clarifier 1202 and into aerobic secondary treatment including MABR 1206 and MBR 1208 to produce an effluent (membrane permeate) 1210. Air 1204 enters MABR 1206 and off-gas 1212 exits MABR 1206. The off-gas 1212 contains O₂ and N₂O that can be fed into CHP 1214 to produce heat, power, and CO₂ and N₂ as output products 1216.

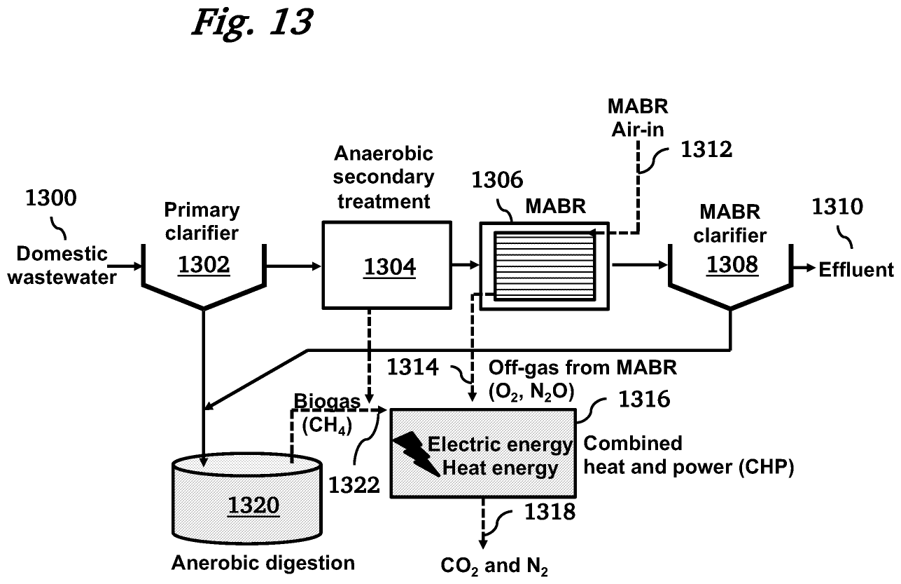

FIG. 13 illustrates another embodiment and potential configuration of application to anaerobic secondary treatment 1304 followed by an MABR 1306 and clarifier 1308. MABR off-gas 1314 will be coupled to the CHP 1316 combusting biogas 1322 produced from anaerobic digestion 1320 and anaerobic secondary treatment 1304. Here, MABR can incorporate any BNR system, such as SHARON, CANON, and SNAD. Domestic wastewater 1300 passes through primary clarifier 1302, anaerobic secondary treatment 1304, MABR 1306 MABR clarifier 1308, to produce effluent 1310. Air 1312 is pumped into MABR 1306, and the off-gas 1314 contains O₂ and N₂O that are fed into CHP 1316 to produce heat, power, and CO₂ and N₂ as output products 1318.

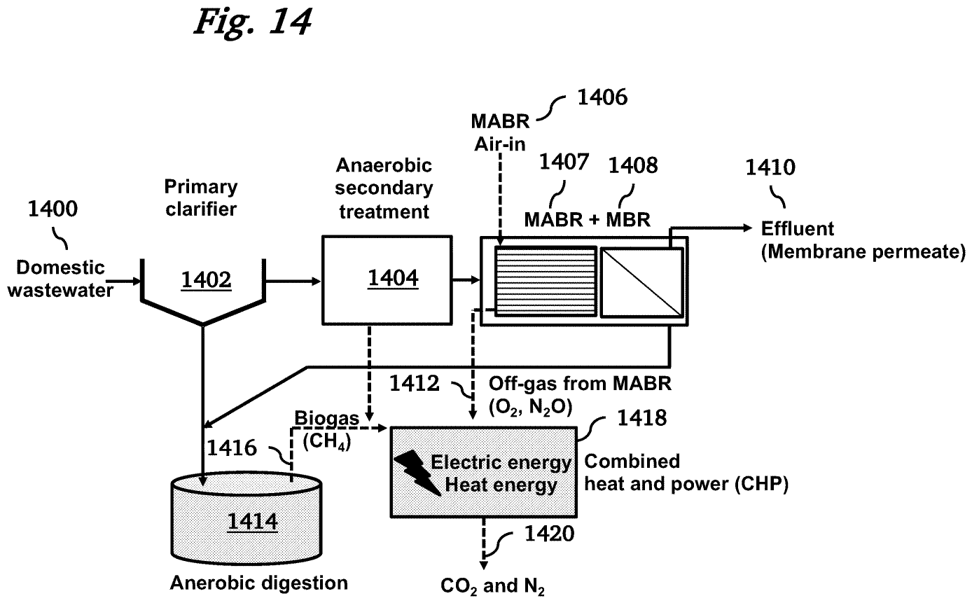

FIG. 14 illustrates another embodiment and potential configuration of application to anaerobic secondary treatment, such as UASB, AFBR, AnMBR, and SAF-MBR, 1404 followed by MABR 1407 and MBR 1408. MABR off-gas 1412 will be coupled to the CHP 1418 combusting biogas 1416 produced from anaerobic digestion 1414 and anaerobic secondary treatment 1404. Here, MABR 1407 can incorporate any BNR, such as SHARON, CANON, and SNAD. The domestic wastewater 1400 enters primary clarifier 1402 then passes through anaerobic secondary treatment 1404 after which it enters MABR 1407 and MBR 1408 to produce effluent (membrane permeate) 1410. Air 1406 enters MABR 1407, and off-gas 1412 from MABR 1407 is fed to CHP 1418 which produces electric and heat energy as well as CO₂ and N₂ as output products 1420.

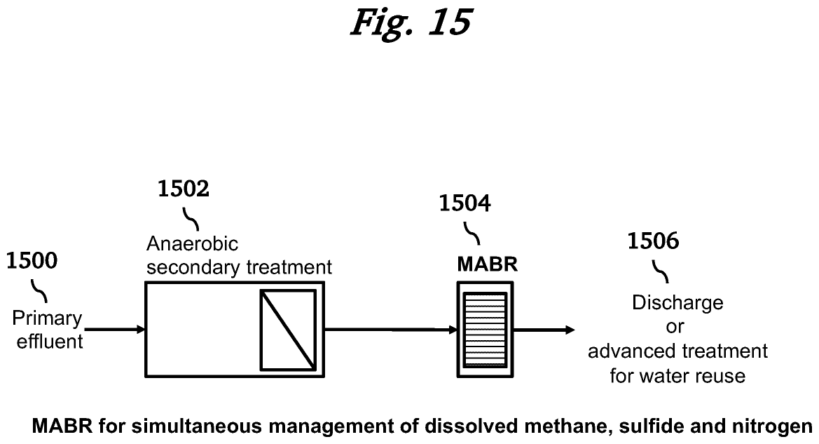

For the configurations above with anaerobic secondary treatment followed by MABR, MABR also provides simultaneous management of dissolved methane, sulfide and nitrogen in anaerobic secondary effluent. FIG. 15 illustrates this for a system in which primary effluent 1500 enters anaerobic secondary treatment 1502 where the output enters MABR 1504 producing a discharge or effluent for advanced treatment water reuse 1506.

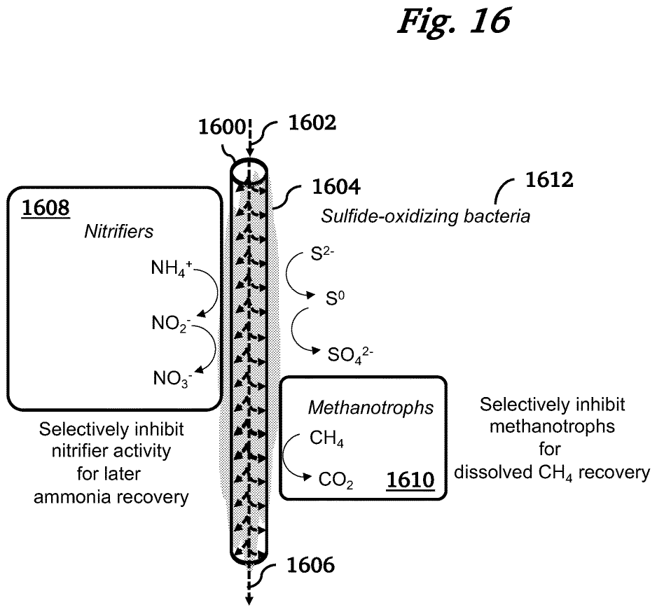

FIG. 16 illustrates details for the configurations above with anaerobic secondary treatment of effluent 1602 followed by MABR. Biofilm 1604 on gas permeable membrane 1600 can include sulfide-oxidizing bacteria 1612, nitrifiers 1608, and methanotrophs 1610. Nitrifiers 1608 can be selectively inhibited for later ammonia recovery from the outflow 1606. Methanotrophs 1610 additionally enable further greenhouse gas emission control by oxidizing dissolved methane. But its activity can be selectively inhibited for dissolved methane recovery. Inhibitions of specific microbial activity can be achieved by controlling the residence time of microorganisms within biofilms or providing inhibitors.

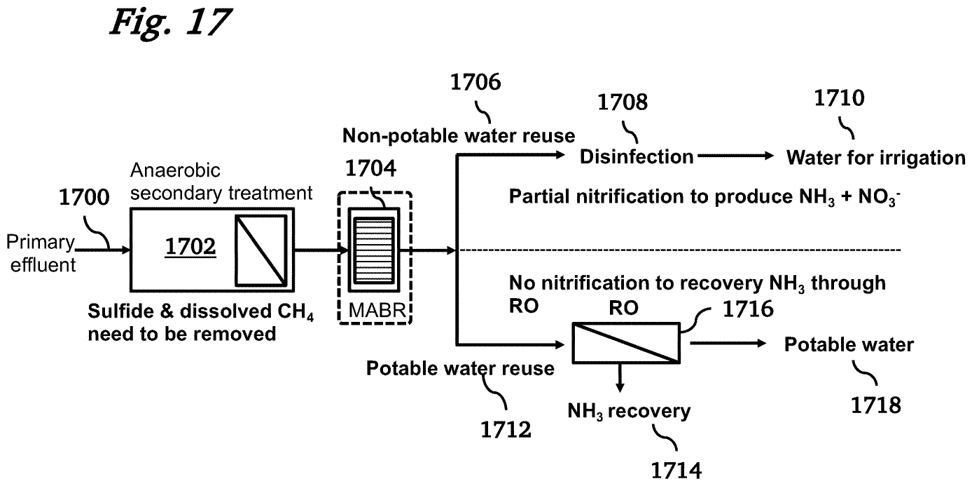

FIG. 17 illustrates further details for the configurations with anaerobic secondary treatment 1702 of primary effluent 1700 followed by MABR 1704 with nitrifier activity controls for subsequent ammonia recovery in water reuse trains. For non-potable water reuse, activity of nitrifiers in MABR can be partially inhibited to produce effluent 1706 containing ammonia and nitrate for use as water for irrigation 1710 after disinfection 1708. For potable water reuse, activity of nitrifier in MABR can be selectively inhibited to produce effluent 1712 containing ammonia for ammonia recovery 1714 through reverse osmosis (RO) 1716 while producing potable water 1718.

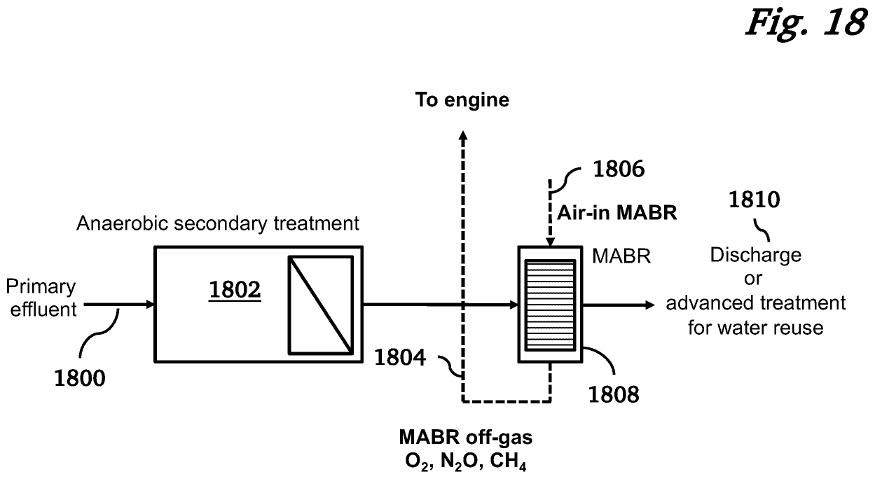

FIG. 18 illustrates further details for the configurations with anaerobic secondary treatment 1802 followed by MABR 1808 with inhibited methanotrophic activity. Gas permeable membranes in MABR 1808 can provide two degasification functions for N₂O and dissolved CH₄ recovery from the off-gas 1808. This configuration can enable further recovery of energy by combusting more methane from effluent from anaerobic secondary treatment 1802. In this configuration, primary effluent 1800 passes through anaerobic secondary treatment 1802 and subsequently through MABR 1808 which produces discharge or effluent for advanced treatment for water reuse 1810. Air 1806 is injected into MABR 1808, and off-gas 1808 from MABR 1808 containing oxygen, nitrous oxide, and methane is sent to an engine for energy production.

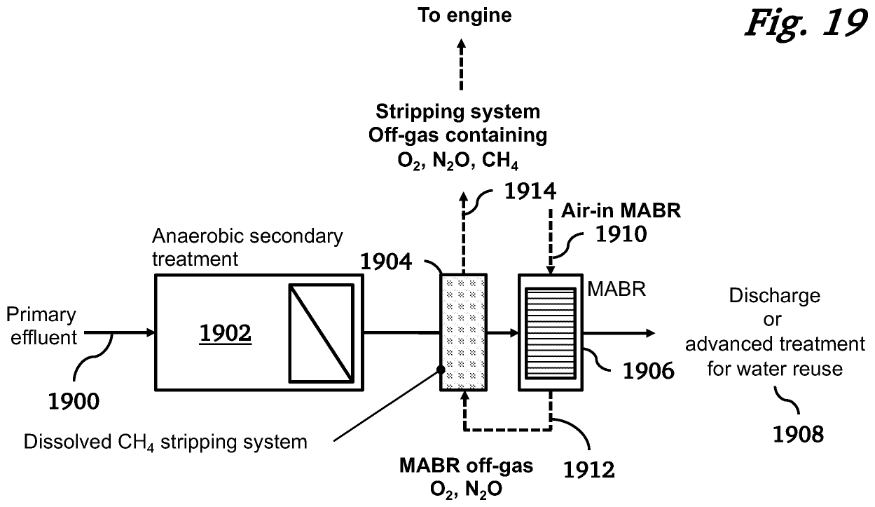

FIG. 19 illustrates further details for the configurations with anaerobic secondary treatment 1902 of primary effluent 1900. MABR 1906 can be followed by dissolved methane stripping system 1904 when dissolved methane needs to be recovered before MABR 1906. In this case, off-gas 1912 from the MABR 1906 can be used as a stripping gas for the dissolved methane stripping system 1904. The final off-gas 1914 from the stripping system 1904 will then contain O₂, N₂O, and CH₄. This configuration can enable further recovery of energy by combusting more methane from effluent from anaerobic secondary treatment 1902. The outflow from MABR 1906 is a discharge or effluent for advanced treatment for water reuse.

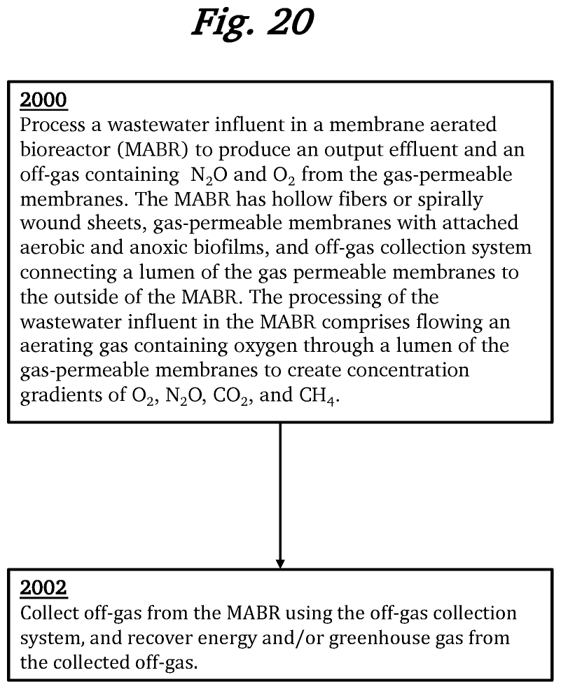

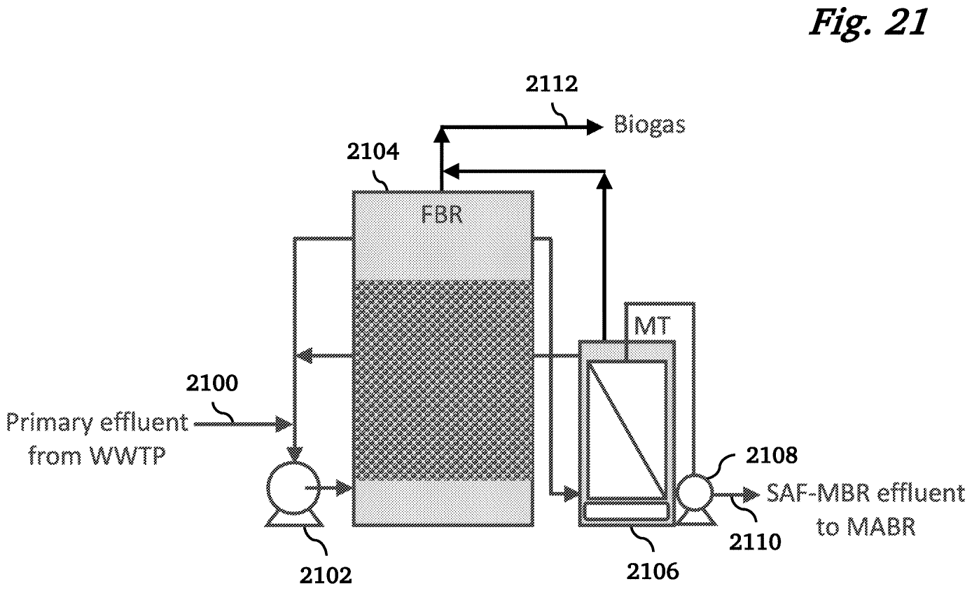

FIG. 20 is a flowchart outlining a method for biologically treating wastewater according to an embodiment of the invention. Step 2000 involves processing a wastewater influent in a membrane aerated biofilm reactor (MABR) to produce an output effluent and off-gas from the gas-permeable membranes; wherein the off-gas comprises N₂O and O₂. The MABR includes gas-permeable membranes with attached aerobic and anoxic biofilms, hollow fibers or spirally wound sheets or another gas-permeable membrane configuration, and an off-gas collection/extraction system from a lumen of the gas permeable membranes to outside of the MABR. The processing in the MABR involves flowing an aerating gas comprising oxygen through a lumen of the gas-permeable membranes to create concentration gradients of oxygen, N₂O, CO₂, and methane. Off-gas is collected from an off-gas collection system in a beneficial use system such as an energy recovery system that produces energy from the off-gas.

### Experiments

To further illustrate the features of the present invention, we now discuss experimental results from the application of a pilot-scale MABR (>8.2 m³/d) that treated effluent from a demonstration-scale SAF-MBR system (90 m³/d, Shin et al., 2022b) the course of a year. The experimental study quantified N₂O production and recovery from the pilot-scale MABR.

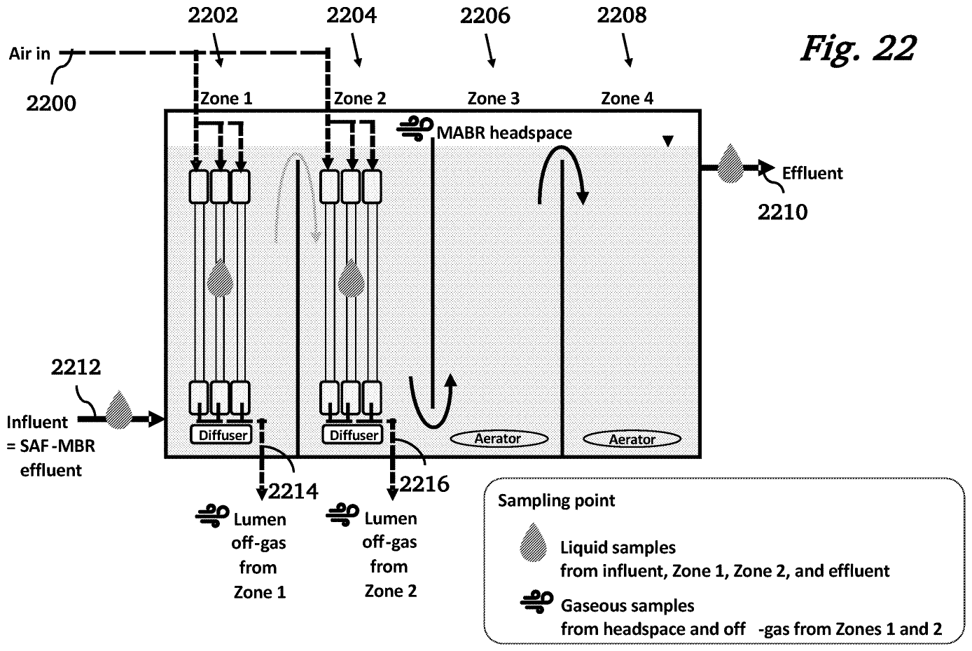

FIG. 22 is a schematic diagram of a demonstration-scale staged anaerobic fluidizing membrane bioreactor (SAF-MBR) system feeding a pilot-scale MABR. A primary effluent 2100 from a wastewater treatment plant (WWTP) enters the fluidized bed reactor (FBR) 2104 via pump 2102. Effluent flow from FBR to a membrane tank (MT) 2106 and the resulting effluent exits MT via pump 2108 as SAF-MBR effluent 2110 to an MABR. A biogas also exits FBR 2104 and MT 2106. The system was installed at Silicon Valley Clean Water (Redwood City, CA), a centralized domestic WWTP, as described in Shin et al., 2022 CEC. The influent to the SAF-MBR system was primary effluent 2100 from the treatment plant. The SAF-MBR has a fluidized bed reactor 2104 (FBR, 2 m×2 m×6 m) and a membrane tank 2106 (MT, 0.84 m×0.69 m×3 m), containing 9 ZeeWeed 500D ultrafiltration membrane modules (Veolia) with a nominal pore size of 0.04 μm. The SAF-MBR system operated about one year prior to the pilot-scale MABR operation, including a 60-day start-up time for stabilization of the anaerobic microorganisms, a 100-day for transitional operation involving reduction of the hydraulic retention time (HRT) from 10 to 5 hours, and more than 200 days at steady-state operation with a 5-hour HRT and 22-day SRT while treating 90 m³/d primary effluent from the WWTP. The SAF-MBR system operated without temperature control, such that wastewater temperature varied from 15 to 25 °C depending upon seasonal variations. At steady-state operation, the SAF-MBR produced high-quality effluent (COD less than 50 mg/L and TSS less than 1 mg/L) while enabling 0.25 kWh/m³ net energy-positive operation (0.50 kWh/m³ methane energy production potential −0.25 kWh/m³ for the energy requirement for the SAF-MBR operation, Shin et al., 2022b).

FIG. 22 is a schematic diagram of a pilot-scale MABR with various sampling points indicated. The system has four chambers (2202, 2204, 2206, 2208) that were hydraulically divided by baffles, and through which the liquid flowed in a plug-flow fashion. Air 2200 is injected into zones 2202, 2204. Lumen off-gas exits zones 2202, 2204 through extraction tubes 2214, 2216. Influent 2212 enters zone 2202 and flows alternatively up and down through zones 2202, 2204, 2206, 2208 and then exits as effluent 2210. Each zone/chamber had a volume of 0.95 m³ (0.36 m (W)×2.4 m (H)×1.1 m (L)). Zones 2202, 2204 were biologically active chambers containing gas permeable membranes on which aerobic biofilms grew, while Zones 2206, 2208 were empty chambers without membranes. Aerators at the bottom of Zones 2206, 2208 provided a completely mixed condition to avoid dead zones where sediments might accumulate. The system was automated and controlled using the Veolia Insight System, an industrial supervisory control and data acquisition (SCADA) system.

TABLE 1
Pilot-scale MABR operating conditions per operational periods

| Opera- | Opera- | Flow | | Diffuser sparging |
|---|---|---|---|---|
| tional | tional | rate | Diffuser sparging for | to control biofilm |
| Period | Day | (m³/d) | mixing | thickness |
| I | 1~97 | 8.2 | 10 s every 2 min (8%) | 3 min every 12 h |
| II | 98~174 | 16.4 | 10 s every 2 min (8%) | 3 min every 12 h |
| III | 175~181 | 16.4 | 10 s every 2 min (8%) | Disabled |
| IV | 182~190 | 16.4 | 5 s every 10 min | Disabled |
| | | | (0.8%) | |
| V | 191~194 | 32.7 | 5 s every 10 min | Disabled |
| | | | (0.8%) | |
| VI | 195 ~325 | 32.7 | 5 s every 2 min (4%) | Disabled |

Zones 2202, 2204 contained three gas permeable membrane modules (ZeeLung, Veolia) and diffusers on the bottom of each chamber. Each gas permeable membrane module had a membrane surface area of 40 m², yielding an overall membrane surface area of 240 m² for the MABR system. The six gas permeable membrane modules in Zones 2202, 2204 received continuous compressed air 2200 (0.51 Nm³/h with relative pressures of 47.6 kPa at the inlet and 26.9 kPa at the outlet), enabling sufficient oxygen supply to support aerobic biofilms on the membrane surface. The air lumen of the gas permeable membranes created an oxygen concentration gradient, facilitating efficient delivery of oxygen to the aerobic biofilm on the surface of the membranes. The diffusers on the bottom of the ZeeLung membrane modules in Zones 2202, 2204 intermittently delivered compressed air for two functions: (1) mixing water around the ZeeLung membranes (24 Nm³/h) and (2) controlling biofilm thickness (48 Nm³/h). The frequency of intermittent sparging was varied depending upon operational conditions to control biological activities, as summarized in Table 1.

The MABR was seeded with returned activated sludge (RAS) from the Regional Water Quality Control Plant in Palo Alto (CA) to introduce aerobic bacteria including nitrifiers. Half of the MABR volume was seeded with RAS, and the rest of the volume was filled with the SAF-MBR effluent, which resulted in a mixed liquor suspended solids (MLSS) concentration of 4940 mg/L and a mixed liquor volatile suspended solids (MLVSS) concentration of 4120 mg/L. After the seeding, the MABR system was operated in batch mode for two days to facilitate biofilm formation on the aerating membranes. The gas permeable membranes maintained oxygen-rich conditions to attract the aerobic bacteria, and the MABR was fed with SAF-MBR effluent in a batch fashion (daily, 25% of the MABR effective volume) to provide substrates, such as ammonia and sulfides. During the batch operation, the MABR effluent maintained a high nitrate (NO₃⁻) concentration (46 mg-N/L), constituting 92% of the total nitrogen concentration (excluding biomass), implying high nitrifier activity. After two days of stabilization, the MABR was converted to operating in a continuous operation mode, receiving 8.2 m³/d of SAF-MBR effluent. The continuous flow washed out dispersed biomass in the bulk liquid.

Liquid and gaseous samples were collected from the pilot-scale MABR locations illustrated in FIG. 22. For liquid samples, analyses included sulfides, sulfide oxidation products (elemental sulfur (S⁰), thiosulfate (S₂O₃²⁻), and sulfate (SO₄²⁻)), chemical oxygen demand (COD), suspended solids (SS), nitrogen species, and dissolved CH₄. Sulfides are unstable and were analyzed in the field by the colorimetric methylene blue method (SM 4500-S2 D). Elemental sulfur was extracted using a two-fold volumetric excess of chloroform and the chloroform extract was analyzed by HPLC-UV at 263 nm using a Hypersil GOLD reversed-phase C18 column (Rethmeier et al., 1997). Thiosulfate and sulfate were measured by ion chromatography (Dionex Integrion IC system) using a Dionex IonPac AS11 column (Thermo Scientific). COD was measured by using COD Hach kits based on the colorimetric method (SM 5200 D). Suspended solids were measured after filtering samples using glass fiber filter papers (934-AH™ RTU, Whatman), according to SM 2540 D. Nitrogen species (NH₃, NO₂⁻, and NO₃⁻) were also measured by using Hach kits based on the colorimetric methods described in SM 4500 and EPA 353.2. Dissolved CH₄ concentrations were measured by headspace analysis using a gas chromatography system that incorporates a thermal conductivity detector (GC-TCD, GOW-MAC), as detailed in Shin et al. (2016).

For gaseous samples, CH₄ and CO₂ concentrations were measured with the GC-TCD, and N₂O concentrations were analyzed by a gas chromatography system that featured an electron capture detector (GC-ECD, GC-2014, Shimadzu). Residual O₂ concentrations in the lumen off-gas from Zones 1 and 2 were continuously monitored using O₂ sensors (T7OX-V CRL, City Technology LTD.) and logged in the InSight system (Veolia). Data from other sensors were collected through the InSight system (Veolia), including flowrates and pressures to evaluate the energy requirements for the pilot-scale MABR operation.

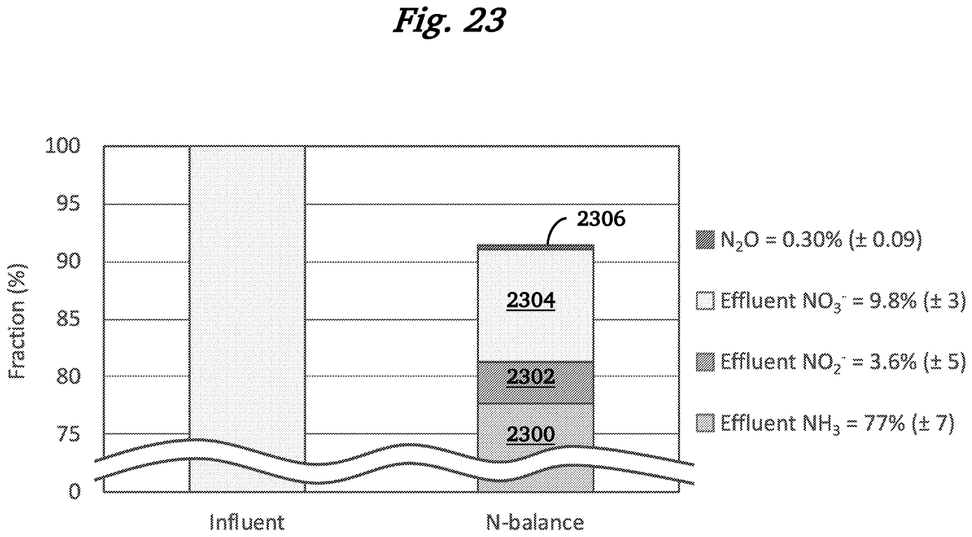

Effluent ammonia and the ammonia oxidation products, nitrite, nitrate and nitrous oxide (N₂O; including dissolved N₂O and N₂O in the off-gas from Zones 2202, 2204) were analyzed to develop a nitrogen mass balance during Periods I and III, when the MABR ammonia removal efficiency exceeded 20%. FIG. 23 shows influent ammonia (left column) and inorganic nitrogen species in the MABR effluent, including gas phase N₂O (right column), as a fraction (%) of the influent ammonia. Because nitrous oxide (N₂O) can be an intermediate during nitrification, the N₂O concentration in MABR aqueous samples was measured in the gas phase headspace above aqueous samples after equilibration. Background samples of atmospheric air indicated 439~457 ppb N₂O as a baseline. In contrast, analysis of the headspace for aqueous MABR effluent samples indicated 210~494 ppb N₂O, corresponding to 2.3×10⁻⁴~5.8×10⁻⁴ mg-N₂O/L dissolved N₂O concentrations.

N₂O can also diffuse from the biofilm to the gas within the air lumens of the MABR membranes, which is then vented through the lumen off-gas. The N₂O composition in the off-gas from the air lumens of the MABR membranes was measured to calculate the gaseous N₂O emission rate. The gas phase concentrations were 99~223 ppm in the off-gas from the lumens from Zone 1 and 43~57 ppm from Zone 2. The gaseous N₂O production rate from biological activity (mg-N/min) was then divided by the MABR aqueous flow rate (L/min) to derive an N₂O value in mg-N/L. It should be emphasized that these N₂O concentrations within the off-gas from the lumens of the MABR membranes were at ppm concentrations, which are at least ×100 times more concentrated than the ppb concentrations measured for headspace analysis of MABR aqueous effluent samples or in ambient air. To the best of our knowledge, this is the first time that N₂O has been reported to be released through the gas permeable membranes within a MABR.

Overall, 77% of the influent ammonia remained within the effluent on a mean basis (2300, right column). Of the 23% degraded, nitrite constituted 3.6% (2302, right column), nitrate accounted for 9.8% (2304, right column), and N₂O fraction only 0.30% (2306, right column). A portion of the 8% difference between the influent and effluent nitrogen balance may be attributed to ammonia used for cell assimilation.

The carbon footprint of the pilot-scale MABR was assessed by considering incidental nitrous oxide (N₂O) emission during nitrification with its respective 100-year global warming potential (GWP₁₀₀) value of 298 kg-CO₂ eq/kg-N₂O (IPCC, 2013). The use of electricity can have an additional carbon footprint of 0.38 kg-CO₂ eq/kWh (US EIA, 2020), which however is not considered within the MABR operation because we assume it can be fully compensated by the net energy production of the SAF-MBR system, as discussed previously.

Monitored N₂O composition in the off-gas from the membrane lumens ranged from 223 to 99 ppm from Zone 1 and 57 to 43 ppm from Zone 2. The dissolved N₂O concentration produced from nitrification ranged from 0.023 to 0.054 mg-N₂O/L. This result indicates, for the first time, that more than 99.9% of N₂O emissions were found in the off-gas from the membrane lumens in the MABR. The gas permeable membranes are used to deliver oxygen to the biofilm on the surface of membranes, based on diffusion. But we found that there is counter-diffusion of other gases, especially N₂O, because the biofilm creates a concentrated N₂O concentration, which then diffuses back into the membrane lumen where N₂O concentration is relatively low due to the continuous flow of air.

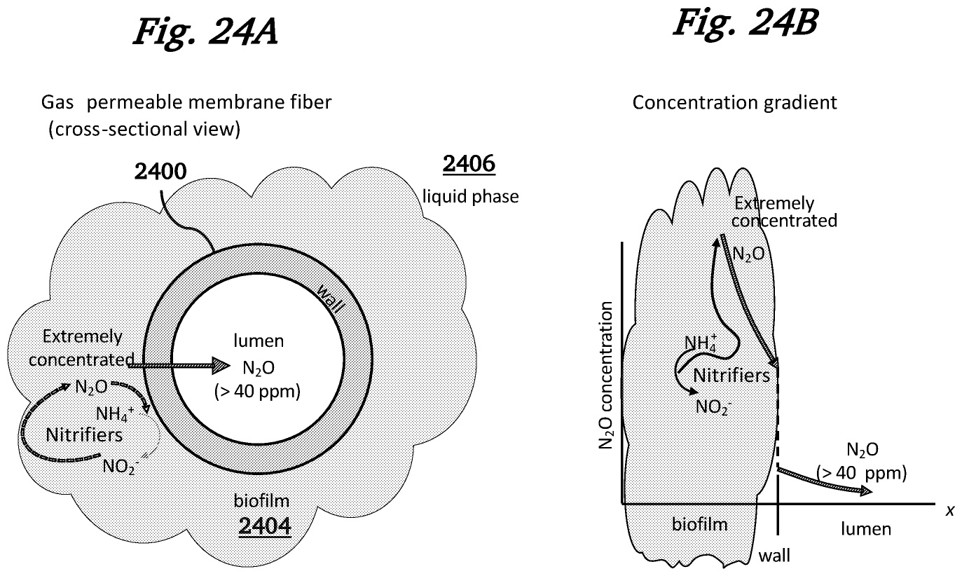

FIGS. 24A-24B illustrate how the N₂O can be recovered through the membrane lumen. Specifically, FIG. 24A shows counter-diffusion of N₂O from the biofilm to the membrane lumen. A cross-sectional view of the gas permeable membrane fiber having membrane wall 2400 forming an interior lumen 2402 and biofilm 2404 attached to the membrane 2400. Outside the biofilm is a liquid phase 2406. FIG. 24B shows a graph of the N₂O concentration gradient as a function of penetration distance x into the fiber.

The off-gas can be separately managed, enabling control of N₂O emissions. For example, the off-gas line from the MABR could be routed with the biogas from the SAF-MBR to a co-generator or combined heat and power (CHP) facility used for energy generation. N₂O will act as an additional oxidant along with O₂ within a CHP and be reduced to N₂, enabling complete N₂O emission control (Scherson and Criddle, 2014). Furthermore, N₂O is a more potent oxidant than O₂, improving energy generation while combusting the same amount of biogas. Therefore, the combination of the SAF-MBR and MABR can enable a reduction in carbon footprint while controlling N₂O emissions and generating more power.

The MABR system still has a carbon footprint because of the dissolved N₂O concentration within its effluent: 0.023 to 0.054 mg-N₂O/L, corresponding to a carbon footprint of 6.8×10⁻³ to 1.6×10⁻² kg-CO₂ eq/m³ treated water. This carbon footprint is over 97% smaller than conventional aerobic systems practicing biological nitrogen removal (5.3×10⁻¹ kg-CO₂ eq/m³ with 1.7% N₂O emission; Shin et al., 2022a). The carbon footprint from the MABR is over 93% smaller than conventional aerobic systems without biological nitrogen removal (2.5×10⁻¹ kg-CO₂ eq/m³ with 0.8% N₂O emission; Shin et al., 2022a).

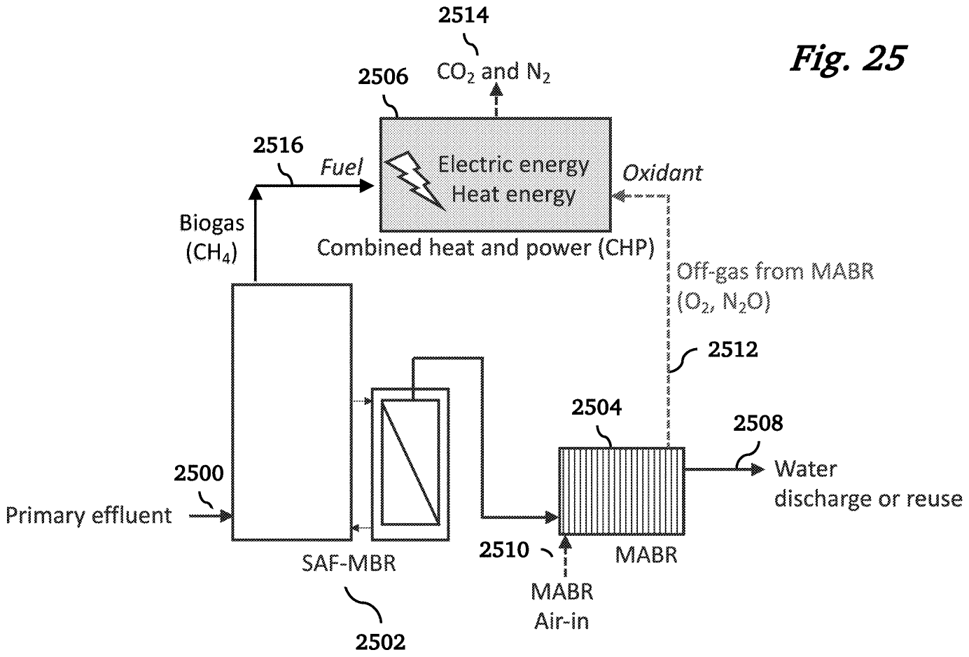

FIG. 25 is a diagram illustrating an SAF-MBR 2502 followed by MABR 2504 process train for energy- and carbon efficient secondary treatment of primary effluent 2500. This process train including a SAF-MBR followed by a MABR injected with air 2510 can thus enable energy- and carbon-efficient water reuse: biogas 2516 from the SAF-MBR 2502 combusted with off-gas 2512 from the MABR 2504 in a CHP 2506 generates more energy than needed for the process train operation while producing gas products 2514 minimizing N₂O emissions. The MABR effluent 3008 can be discharged or reused after filtration and disinfection to meet turbidity and pathogen control requirements.

These experiments demonstrated the feasibility of N₂O recovery using a MABR at pilot-scale. Findings include: The lumen off-gas from the gas permeable membranes contained over 99.9% of the produced N₂O during nitrification. The N₂O in MABR off-gas can be combusted together with the CH₄ from SAF-MBR biogas to enable N₂O emission control while generating increased power. The carbon footprint of the MABR operation was as small as 6.8×10⁻³ to 1.6×10⁻² kg-CO₂ eq/m³ treated water, more than 93% lower than that of a conventional aerobic secondary process.

### REFERENCES

Evans, P. J., Doody, A., Harclerode, M., Brower, A., Vila, P., McCarty, P. L., Parker, W., Parameswaran, P., Lim, K., Bae, J., Shin, C., Lee, P., Tan, A., Guy, K., Page, M., Maga, S., 2018, Anaerobic membrane bioreactor (AnMBR) for sustainable waste-water treatment. In: Environmental Security Technology Certification Program Project (ESTCP Project ER-201434).
IPCC 2013: Stocker, T. F.; Qin, D.; Plattner, G. K.; Tignor, M.; Allen, S. K.; Boschung, J.; Nauels, A.; Xia, Y.; Bex, V.; Midgley, P. M. IPCC 2013: the physical science basis: Working Group I contribution to the Fifth assessment report of the Intergovernmental Panel on Climate Change. Cambridge University Press. 2014.
IPCC 2019: Calvo Buendia, E.; Tanabe, K.; Kranjc, A.; Baasansuren, J.; Fukuda, M.; Ngarize, S.; Osako, A.; Pyrozhenko, Y.; Shermanau, P.; Federici, S. 2019 Refinement to the 2006 IPCC Guidelines for national greenhouse gas inventories. IPCC, Switzerland, 2019.
Lee, E., Rout, P. R., Kyun, Y., & Bae, J. (2020). Process optimization and energy analysis of vacuum degasifier systems for the simultaneous removal of dissolved methane and hydrogen sulfide from anaerobically treated wastewater. Water Research, 182, 115965.
Rethmeier, J., Rabenstein, A., Langer, M., & Fischer, U. (1997). Detection of traces of oxidized and reduced sulfur compounds in small samples by combination of different high-performance liquid chromatography methods. Journal of chromatography A, 760 (2), 295-302.
Scherson, Y. D., & Criddle, C. S. (2014). Recovery of freshwater from wastewater: upgrading process configurations to maximize energy recovery and minimize residuals. Environmental science & technology, 48 (15), 8420-8432.
Shin, C., Bae, J., & McCarty, P. L. (2012). Lower operational limits to volatile fatty acid degradation with dilute wastewaters in an anaerobic fluidized bed reactor. Bioresource technology, 109, 13-20.
Shin, C., McCarty, P. L., Kim, J., & Bae, J. (2014). Pilot-scale temperate-climate treatment of domestic wastewater with a staged anaerobic fluidized membrane bioreactor (SAF-MBR). Bioresource Technology, 159, 95-103.
Shin, C., L McCarty, P., & Bae, J. (2016). Importance of dissolved methane management when anaerobically treating low-strength wastewaters. Current Organic Chemistry, 20 (26), 2810-2816.
Shin, C., Tilmans, S. H., Chen, F., McCarty, P. L., & Criddle, C. S. (2021a). Temperate climate energy-positive anaerobic secondary treatment of domestic wastewater at pilot-scale. Water Research, 204, 117598.
Shin, C., Tilmans, S. H., Chen, F., & Criddle, C. S. (2021b). Anaerobic membrane bioreactor model for design and prediction of domestic wastewater treatment process performance. Chemical Engineering Journal, 426, 131912.
Shin, C., Szczuka, A., Liu, M. J., Mendoza, L., Jiang, R., Tilmans, S. H., Tarpeh, A. W., Mitch, A. W. & Criddle, C. S. (2022a). Recovery of clean water and ammonia from domestic wastewater: impacts on embodied energy and greenhouse gas emissions. Environmental Science & Technology, 56 (12), 8712-8721.
Shin, C, Szczuka, A., Berglund-Brown, J. P., Chen, H. K., Quay, A. N., MacDonald, J. A., Chen, F., Tilmans, S., Mitch, W. A. & Criddle, C. “Maximizing water and energy recovery from new anaerobic secondary wastewater treatment technology”, California Energy Commission Final Report: CEC-500-2022-XXX, 2022b.
U.S. Energy Information Administration, 2020. https://www.eia.gov/tools/faqs/faq.php?id=74&t=11#:~:text=In%202020%2C%20total%20U.S.%20electricity,CO2%20emissions%20per%20 kWh.

1. A method for biological treatment of wastewater based upon a membrane aerated biofilm reactor (MABR), comprising:
a) processing a wastewater influent in a membrane aerated biofilm reactor (MABR) to produce an output effluent and an off-gas from gas-permeable membranes of the MABR;
wherein the off-gas comprises N₂O and O₂;
wherein the MABR comprises aerobic and anoxic biofilms attached to the gas-permeable membranes;
wherein the gas-permeable membranes comprise hollow fibers or spirally wound sheets;
wherein the MABR comprises an off-gas collection system connecting a lumen of the gas permeable membranes of the MABR to an exterior of the MABR;
wherein the processing of wastewater influent in the MABR comprises flowing an aerated gas containing oxygen through the lumen of gas-permeable membranes creating concentration gradients for O₂, N₂O, CO₂, and CH₄;
b) collecting the off-gas from the MABR using the off-gas collection system; and
c) recovering energy and/or greenhouse gases from the collected off-gas.

2. The method of claim 1 wherein the wastewater influent is an effluent from a secondary wastewater treatment system.

3. The method of claim 1 wherein the wastewater influent is an effluent from a primary wastewater treatment system.

4. The method of claim 1 wherein a concentration of N₂O in the off-gas exceeds 1 ppm.

5. The method of claim 1 wherein recovering energy and/or greenhouse gases comprises using a fuel cell generator, biogas combustion system, or combined heat and power (CHP) system to produce energy from the off-gas.

6. The method of claim 1 wherein the aerobic and anoxic biofilms contain heterotrophs, ammonia-oxidizing bacteria (AOB), methane-oxidizing bacteria (MOB), sulfide-oxidizing bacteria (SOB), ammonia-oxidizing archaea (AOA), nitrite-oxidizing bacteria (NOB), or denitrifying anoxic organisms.

7. The method of claim 1 wherein the aerobic biofilms contain organisms that possess ammonia monooxygenase enzymes that consume O₂ and use it to produce hydroxylamine which can be further oxidized to N₂O.

8. The method of claim 1 wherein the gas permeable membranes are composed of polymethyl pentene (PMP).

9. The method of claim 1 wherein the off-gas collection system comprises an exhaust tube, pipe, or gas line.
